(19) United States
(12) Patent Application Publication
(10) Pub. No.: US 2024/0218591 A1
(43) Pub. Date: Jul. 4, 2024

(54) NON-SOLVENT PU SYSTEM, AN ARTIFICIAL LEATHER COMPRISING THE SAME AND A PROCESS FOR PRODUCING THE ARTIFICIAL LEATHER

(71) Applicant: BASF SE, Ludwigshafen Am Rhein (DE)

(72) Inventors: Chang Xi LI, Shanghai (CN); Guang Hui HAN, Shanghai (CN); Zhong Kai ZHANG, Shanghai (CN)

(21) Appl. No.: 18/550,076

(22) PCT Filed: Mar. 28, 2022
(86) PCT No.: PCT/EP2022/058122

§ 371 Date: Sep. 11, 2023

(30) Foreign Application Priority Data
Apr. 13, 2021 (WO) PCT/CN2021/086998

(51) Int. Cl. D06N 3/14; D06N 3/00

(52) U.S. Cl. CPC D06N 3/145; D06N 3/0059; D06N 3/0097; D06N 3/147

(57) ABSTRACT

Disclosed herein is a non-solvent polyurethane system, which includes catalysts of at least a non-tin metal compound with an amine-based catalyst. Further disclosed herein is an artificial leather including a top coat, a first polyurethane layer made from the non-solvent polyurethane system, optionally a further polyurethane layer and optionally a substrate layer. Additionally disclosed herein is a process for producing an artificial leather thereof.

### TECHNICAL FIELD

The present invention relates to a non-solvent polyurethane system, which comprises catalysts of at least a non-tin metal compound with an amine-based catalyst. An artificial leather comprising a top coat, a first polyurethane layer made from the above non-solvent polyurethane system, optionally a further polyurethane layer and optionally a substrate layer. The present invention further relates to a process for producing the artificial leather thereof.

### BACKGROUND

Non-solvent polyurethane (PU) system used in artificial leather is one of eco-friendly solutions for artificial leather industry. It normally needs aqueous dispersions to form top coat layer and non-solvent polyurethane sheet as base coat layer. Most non-solvent polyurethane (PU) system needs catalysts from organotin catalyst and/or thermally activatable catalysts to achieving good curing during the manufacturing of artificial leather. However, the curing usually needs to be at a high temperature of above 110° C., sometimes even above 150° C.

WO2013/041397 discloses a process for production of artificial leather comprising top coat, polyurethane layer and optional substrate layer, said process comprising i) providing a release layer, ii) applying one or more than one layer of a top coat to the release layer to an overall top coat layer thickness in the range from 1 to 500 μm, iii) applying first polyurethane system components comprising an isocyanate component (A) and a polyol component (B) to the top coat to form a first polyurethane layer, iv) optionally applying further polyurethane system components to the first polyurethane layer to form further polyurethane layers, v) optionally applying a substrate layer to the polyurethane system components, vi) curing the polyurethane system components to form a polyurethane layer, and vii) separating the release layer from the top coat.

CN104088161B discloses a method for preparing a solvent-free environmentally friendly polyurethane automotive leather. The automotive leather includes a surface layer and a foamed layer. The surface layer and the foamed layer are both two-component solvent-free polyurethane. The solvent-free environmentally friendly polyurethane surface layer resin and the solvent-free environmentally friendly polyurethane foam layer resin used in the foam layer are respectively composed of the solvent hydroxyl mixture A component and the isocyanate B component; the specific preparation method of the automobile leather includes: scraping the fabric, Fabric drying, scraping foam layer resin, semi-dry laminating base fabric, curing, winding several steps. The present invention uses solvent-free environmentally friendly polyurethane resin to prepare automobile leather in one step on a dry production line. The preparation method abandons the wet process flow in the traditional polyurethane automobile leather production, and the production process is reduced by half, and there is no organic solvent emission. The finished product is green and environmentally friendly.

CN110066373 discloses a solvent-free polyurethane resin for synthetic leather, a preparation method thereof, and application in aqueous/solvent-free polyurethane synthetic leather. The invention provides a solvent-free polyurethane resin for synthetic leather, which is formed by mixing and reacting component A and component B at a mass ratio of 1:2-2:1; wherein, component A includes polyol, small molecule chain extender, crosslinking agent, water, catalyst, foam stabilizer; the B component includes polyol, isocyanate, dimethylolpropionic acid. The solvent-free polyurethane resin for synthetic leather provided by the invention does not contain any organic solvents, has low energy consumption and high production efficiency.

Therefore, it is still required to provide new non-solvent polyurethane system, which may have good curing property at lower curing temperature during the manufacturing of artificial leather, meanwhile eco-friendly by not containing an organotin compound as catalyst.

### SUMMARY OF THE INVENTION

An object of this invention is to overcome the problems of the prior art discussed above and to provide a non-solvent polyurethane system, an artificial leather comprising a top coat, a first polyurethane layer made from the above non-solvent polyurethane system, optionally a further polyurethane layer and optionally a substrate layer. Meanwhile, the present invention further provides a process for producing the artificial leather at a curing temperature of 100° C. or below.

Surprisingly, it has been found by the inventors that the above object may be achieved by providing a non-solvent polyurethane system formed with the reactants of
(A) an isocyanate component
(B) polyol composition.
wherein the polyol composition (B) comprises catalysts of a non-tin metal compound and an amine-based catalyst.

In a preferable embodiment of the invention, the non-tin metal compound is a compound selected from at least one from Zinc, bismuth or calcium contained organic metal catalyst, and the amount of the non-tin metal compound is in the range from 0.01 wt % to 10 wt %, preferably from 0.05 to 5 wt %, more preferably from 0.05 to 1 wt %, based on the total weight of polyol composition (B).

In a preferable embodiment of the invention, the amine-based catalyst is a blocked amine catalyst, and the amount of the amine-based catalyst is in the range from 0.01 wt % to 10 wt %, preferably from 0.05 to 5 wt %, more preferably from 0.05 to 1 wt %, based on the total weight of polyol composition (B)

In a preferable embodiment of the invention, the polyol composition (B) comprises polyetherols and/or polyesterols, wherein the polyetherols comprises polytetrahydrofuran

In a preferable embodiment of the invention, the isocyanate component (A) comprises polyisocyanates.

In a preferable embodiment of the invention, the isocyanate index of the non-solvent polyurethane system is in the range from 80 to 200, preferably from 90 to 160.

Another object of this invention is to provide a process for producing an artificial leather comprising a top coat, a polyurethane layer and an optional substrate layer, the process comprising:
applying at least one layer of a top coat to a release layer to produce an overall top coat layer;
applying a first polyurethane system to the top coat to form a first polyurethane layer; optionally applying a further polyurethane system to the first polyurethane layer to form at least one further polyurethane layer;
optionally applying a substrate layer to the first polyurethane layer or to the further polyurethane layers;
curing the first polyurethane system and optionally the further polyurethane system to form a second polyurethane layer; and
separating the release layer from the top coat, to form an artificial leather,
wherein the first polyurethane system is made from the non-solvent polyurethane system according to the present invention

In a preferable embodiment of the invention, the process for producing an artificial leather is a continuous process.

In a preferable embodiment of the invention, the curing temperature of curing the first polyurethane system and optionally the further polyurethane system to form a second polyurethane layer is from 65° C. to 100° C., preferably from 65° C. to 80° C.

Another object of this invention is to provide an artificial leather comprising
a top coat,
a first polyurethane layer,
optionally a further polyurethane layer, and
optionally a substrate layer, wherein the first polyurethane layer is formed by a polyurethane system according to the present invention.

In a preferable embodiment of the invention, the artificial leather is produced by the process according to the present invention.

Another object of this invention is to provide a use of the non-solvent polyurethane system, the artificial leather of this invention as the upper or covering material in the application of apparel, accessories, cases, electronic devices, furniture, auto upholstery, sports items or leisure products.

It has been surprisingly found that the inventive artificial leather has kept a good peeling strength at a lower curing temperature by using, as forming a first polyurethane layer, innovative non-solvent polyurethane system which is formed from a polyol composition (B) having catalysts of at least a non-tin metal compound with an amine-based catalyst.

### DESCRIPTION OF FIGURES

FIG. 1 shows the process for preparing non-solvent PU artificial leather.

### DETAILED DESCRIPTION OF THE INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article or component.

Unless otherwise identified, all percentages (%) are “percent by weight”.

Unless otherwise identified, the temperature refers to room temperature and the pressure refers to ambient pressure.

The present invention provides a non-solvent polyurethane system formed with the reactants of (A) an isocyanate component and (B) polyol composition, wherein the polyol composition (B) comprises catalysts of a non-tin metal compound with an amine-based catalyst.

In the present invention, the isocyanate component (A) of the reactants in the non-solvent polyurethane system comprises polyisocyanates (a). The polyisocyanates used comprise the customary aliphatic, cycloaliphatic and, more particularly, aromatic di- and/or polyisocyanates. Preference is given to using tolylene diisocyanate (TDI), diphenylmethane diisocyanate (MDI) and mixtures of diphenylmethane diisocyanate and polyphenylene polymethylene polyisocyanates (polymeric MDI), and especially diphenylmethane diisocyanate (monomeric MDI).

The isocyanates or else hereinbelow described isocyanate prepolymers may also be in a modified state, for example through incorporation of uretidione, carbamate, isocyanurate, carbodiimide or allophanate groups. It is further possible to use blends of the various isocyanates. Carbodiimide-modified isocyanates are preferably used. They are preferably used in an amount of 1% to 20% by weight and more preferably in an amount of 2% to 10% by weight, based on the overall weight of isocyanate component (A).

The polyisocyanates (a) can also be employed in the form of polyisocyanate prepolymers. These prepolymers are known in the prior art. They are prepared in a conventional manner by reacting above-described polyisocyanates (a) with hereinbelow described compounds having isocyanate-reactive hydrogen atoms (b) to form the prepolymer. The reaction may for example be carried out at temperatures of about 80° C. The polyol/polyisocyanate ratio is generally chosen such that the NCO content of the prepolymer is in the range from 6% to 25% by weight, preferably in the range from 8% to 24% by weight and more preferably in the range from 10% to 20% by weight. A mixture comprising diphenylmethane diisocyanate and polytetrahydrofuran (PTHF), especially PTHF having a number average molecular weight in the range from 1000 to 2500, is used with particular preference as isocyanate component (A). The NCO content of this mixture is preferably in the range from 8% to 22% and more preferably in the range from 10% to 20%.

In the present invention, the polyol composition (B) of the reactants in the non-solvent polyurethane system may in principle comprise compounds having isocyanate-reactive hydrogen atoms (b). These compounds are such as bear two or more reactive groups selected from OH groups, SH groups, NH groups, NH2 groups and carbon-acid groups, for example β-diketo groups, in the molecule. Depending on the choice of compounds having isocyanate-reactive hydrogen atoms (b), the term polyurethanes herein shall comprise polyisocyanate polyaddition products in general, including polyureas for example.

The polyol composition (B) preferably comprises polyetherols and/or polyesterols. These are commonly known and described for example in “Kunststoffhandbuch Polyurethane” Gunter Oertel, Carl-Hanser-Verlag, 2nd edition 1983, chapter 3.1.1. Alternative designations likewise customary in the pertinent art are polyether polyols or polyether alcohols on the one hand and polyester polyols or polyester alcohols on the other.

When polyesterols are employed, these are typically obtained by condensation of polyfunctional alcohols having from 2 to 12 carbon atoms, preferably from 2 to 6 carbon atoms, with polyfunctional carboxylic acids having from 2 to 12 carbon atoms, examples being succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

When polyetherols are employed, these are generally obtained by known methods, for example by anionic polymerization using alkali metal hydroxides as catalysts and with addition of a starter molecule comprising multiple reactive hydrogen atoms in attachment, from one or more alkylene oxides selected from propylene oxide (PO) and ethylene oxide (EO), butylene oxide and tetrahydrofuran. Useful polyetherols (b) further include so-called low-unsaturation polyetherols. Low-unsaturation polyols for the purposes of this invention are more particularly polyether alcohols comprising less than 0.02 meq/g and preferably less than 0.01 meq/g of unsaturated compounds. Polyether alcohols of this type are obtained via addition of ethylene oxide and/or propylene oxide and mixtures thereof onto at least difunctional alcohols in the presence of so-called double metal cyanide catalysts.

The alkylene oxides may be used individually, alternatingly in succession or as mixtures. The use of an EO-PO mixture leads to a polyether polyol having randomly distributed PO/EO units. It is possible to begin by using a PO-EO mixture and then, prior to termination of the polymerization, continue use of just PO or EO, the product then being a polyether polyol having a PO endcap or, respectively, an EO endcap.

Starter molecules used are typically NH- or OH-functional compounds such as water, amines or alcohols. Preference is given to using di- to hexahydric alcohols, such as ethanediol, 1,2-propanediol, 1,3-propanediol, diethylene glycol, dipropylene glycol, 1,4-butanediol, 1,6-hexanediol, glycerol, trimethylolpropane, pentaerythritol and/or sorbitol.

It is further preferable to use polyetherols obtained by ring-opening polymerization of tetrahydrofuran. These polytetrahydrofurans preferably have a functionality of about 2. They preferably further have a number average molecular weight in the range from 500 to 4000 g/mol, preferably in the range from 700 to 3000 g/mol and more preferably in the range from 900 to 2500 g/mol. Polytetrahydrofuran (PTHF) is also known in the pertinent art under the designations tetramethylene glycol (PTMG), polytetramethylene glycol ether (PTMEG) or polytetramethylene oxides (PTMO).

In addition to the abovementioned polyether polyols, the polyol composition (B) may also comprise customary chain-extending agents, by which this invention understands compounds having 2 or more isocyanate-reactive hydrogen atoms and molecular weights in the range from 42 to less than 400 g/mol.

In one preferred embodiment, the polyol composition (B) comprises one or more constituents selected from
(b-1) a polyol, preferably a polyether polyol, having a number-average molecular weight in the range from 1000 g/mol to less than 10000 g/mol
(b-2) a polyol, preferably a polyether polyol, having a number-average molecular weight in the range from 1000 g/mol to 8000 g/mol
(b-3) a chain-extending agent having a molecular weight of less than 400 g/mol.

In one preferred embodiment, component (b-1) comprises a polyetherol or a polyesterol, more preferably a polyether polyol, having a number average molecular weight in the range from 1000 to less than 10000 g/mol, preferably in the range from 2000 to 8000 g/mol, and more preferably in the range from 4000 to 6000 g/mol as components (b1).

The components (b-1) typically have an average functionality of 1.8 to 6, more preferably of 2.0 to 4 and especially of 3.0 Functionality here refers to the “theoretical OH functionality” calculated from the functionality of the starter molecules used.

Polytetrahydrofuran is more preferably used as component (b-1). More particularly, polytetrahydrofuran having a number average molecular weight in the range from 1000 to 2000 g/mol is used.

The components (b-1) is typically present in composition (B) in an amount from 30% to 100% by weight and preferably from 50% to 90% by weight, based on the overall weight of compounds having isocyanate-reactive hydrogen atoms (b).

In one preferred embodiment, components (b-2) utilize a polyetherol or a polyesterol and more preferably a polyether polyol having a number average molecular weight in the range from 1000 to 8000 g/mol, preferably in the range from 2000 to 7000 g/mol and more preferably in the range from 2000 to 4000 g/mol as a compound having isocyanate-reactive hydrogen atoms (b).

The components (b-2) typically have an average functionality of 1.5 to 3, more preferably of 1.7 to 2.5 and especially of 2.0. Functionality here refers to the “theoretical OH functionality” calculated from the functionality of the starter molecules used.

Component (b-2) is more preferably a polyether polyol obtainable by propoxylation and/or ethoxylation of glycerol or trimethylolpropane, especially with an EO endblock. This polyether polyol preferably has a number average molecular weight in the range from 2000 to 4000 g/mol.

The component (b-2) is typically present in composition (B) in an amount from 5% to 80% by weight and preferably from 10% to 50% by weight, based on the overall weight of compounds having isocyanate-reactive hydrogen atoms (b).

The polyol composition (B) may further comprise chain-extending agents as component (b-3). Suitable chain-extending agents are compounds having two or more isocyanate-reactive hydrogen atoms and a molecular weight below 400 g/mol and are known in the prior art. Preference is given to using 2-functional alcohols having molecular weights below 400 g/mol and especially in the range from 60 to 150 g/mol. Examples are ethylene glycol, propylene glycol, diethylene glycol, 1,4-butanediol, dipropylene glycol, tripropylene glycol. 1,4-Butanediol is preferably used.

The chain-extending agent is typically used in an amount from 2% to 25% by weight, preferably from 3% to 13% by weight and more preferably from 3% to 20% by weight, based on the overall weight of compounds having isocyanate-reactive hydrogen atoms (b).

In one embodiment, the reaction of the polyurethane system takes place in the absence of a blowing agent. The resulting polyurethane layer will then be a compact polyurethane. Compact polyurethane in the context of this invention refers to polyurethanes obtained without addition of blowing agents. The polyurethane layer resulting in this embodiment typically has a density in the range from 0.6 to 1.2 kg/liter and preferably in the range from 0.8 to 1.1 kg/liter.

As the case may be, the polyol composition (b) used may for technical reasons comprise a small proportion of residual water. This will be particularly the case when no water trap is used as component (e). The residual water content is preferably below 0.5% by weight and more preferably below 0.2% by weight, based on the overall weight of composition (B) used.

In one preferred embodiment, a blowing agent (c) may be added to the reaction of components (A) and composition (B). Adding the blowing agent preferably leads to an improvement in the breathability of the resulting polyurethane layer. The blowing agent (c) is preferably a constituent of polyol composition (B).

Useful blowing agents include commonly known chemically or physically acting compounds. Physical blowing agents also include inert gases introduced into and/or dissolved in the starting components, examples being carbon dioxide, nitrogen or noble gases. Water may preferably be used as a chemically acting blowing agent. Examples of physical blowing agents are inert (cyclo)aliphatic hydrocarbons having from 4 to 8 carbon atoms and preferably having a boiling point of less than 60° C. Further examples are dialkyl ethers, esters, ketones, acetals, fluoroalkanes having from 1 to 8 carbon atoms. The physical blowing agents mentioned may be used singly or in any combinations between each other.

The amount in which the blowing agent is used is generally in the range from 0.05 to 10% and preferably in the range from 0.1 to 5%, based on the overall weight of composition (B). The polyurethane layer which results in this embodiment typically has a density of 0.5 to 1.1 kg/liter and preferably of 0.6 to 0.9 kg/liter.

In one preferred embodiment, the polyol composition (B) comprises fillers (d). The customary fillers known in the field of polyurethane chemistry are suitable in general. Examples of suitable fillers are glass fibers, mineral fibers, natural fibers, such as flax, jute or sisal for example, glass flakes, silicates such as mica or glimmer, salts, such as calcium carbonate, chalk or gypsum.

It is preferable to use fillers which create cracks in the resulting polyurethane layer on its being subjected to orientation. These cracks generally lead to enhanced breathability. It is particularly preferable to use calcium carbonate as filler.

The fillers (d) are typically used in an amount from 0.5% to 50% by weight and preferably from 10% to 40% by weight, based on the overall weight of composition (B).

In one preferred embodiment, the polyol composition (B) comprises water traps (e). The customary water traps known in the field of polyurethane chemistry are suitable in general. Examples of suitable water traps are zeolites, especially in the form of zeolite pastes (an example being Baylith® L Paste 3A). Water traps (e) are typically used in an amount from 1% to 10% by weight and preferably from 3% to 8% by weight, based on the overall weight of composition (B).

In one particularly preferred embodiment, the components (A) and composition (B) include from 40% to 70% by weight of polytetrahydrofuran, based on the overall weight of components (A) and composition (B). The polytetrahydrofuran here preferably has a molecular weight as described above.

In the present invention, the reaction to form a non-solvent polyurethane system takes place in the presence of catalysts (f) in polyol composition (B). The catalysts comprise at least a non-tin metal compound (f-1) and an amine-based catalyst (f-2). It has been surprisingly found that the inventive polyurethane system kept a good peeling strength at a lower curing temperature by using such catalyst combination during the artificial leather producing.

In one preferred embodiment, component (f-1) comprises at least one from zinc, bismuth or calcium contained organic metal catalyst, more preferably a Zinc organic metal catalyst.

The component (f-1) typically has a zinc organic metal catalyst selected from zinc neodecanoate, zinc octoate, zinc naphthenate, zinc tallate, zinc (C9˜C14) carboxylate, zinc acetate, zinc diacetylacetonate or zinc (2-ethylhexanoate). If bismuth contained organic metal catalyst is used, it is usually selected from bismuth neodecanoate, bismuth 2-ethylhexanoate and bismuth octanoate. Besides, the calcium bis(2-ethylhexanoate) is also used in this invention.

The component (f-1) is typically present in polyol composition (B) in an amount from 0.01% to 10% by weight, preferably from 0.05% to 5% by weight and more preferably from 0.05% to 1% by weight, based on the overall weight of polyol composition (B).

In one preferred embodiment, component (f-2) comprises an amine-based catalyst, more preferably a thermally activatable catalyst.

The component (f-2) typically has a thermally activatable catalyst which ensures a long open time for applying the polyurethane system components and yet rapid curing at elevated temperature. Thermally activatable catalysts are known and comprise for example acid-blocked, for example carboxylic acid-blocked and especially formic acid-blocked amine catalysts, for example tertiary amine catalysts, N-acetylated amine catalysts. These are obtainable for example by reaction of acids with bases, in the presence or absence of a solvent. Such catalysts are known and are described for example in U.S. Pat. Nos. 4,582,861, 4,232,152, 4,366,084, 4,450,246, 4,617,286, DE19512480, EP0989146, U.S. Pat. Nos. 6,525,107, 5,770,635. In the case of acid-blocked catalysts, the acid component used is preferably carboxylic acids, particularly oleic acid, formic acid, acetic acid, ethylhexyl acid, phenol, ricinoleic acid, linoleic acid and/or p-toluenesulfonic acid. By way of amine catalysts to be blocked it is preferable to use triethylenediamine, dimethylamino-N-methylpiperazine, N,N-diphenyl-N-methylamine, bis(N,N-dimethylaminoethyl) ether, N,N-dimethylaminoethoxyethanol and/or DBU. These blocked amine catalysts are usually present in a solvent dispersant. Glycols, such as propylene glycol, dipropylene glycol, ethylene glycol and/or diethylene glycol, are preferably suitable as solvent/dispersant. It is particularly preferable for catalyst (f-2) to comprise blocked diazabicycloundecene (DBU).

The component (f-2) is typically present in polyol composition (B) in an amount from 0.01% to 10% by weight, preferably from 0.05% to 5% by weight and more preferably from 0.05% to 1% by weight, based on the overall weight of polyol composition (B).

The reaction of component (A) and composition (B) optionally takes place in the presence of further auxiliary and/or addition agents known in the production of polyurethanes, examples being cell regulators, plasticizers, release agents, pigments, surface-active compound and/or stabilizers against oxidative, thermal, hydrolytic or microbial degradation or aging. These are preferably likewise a constituent part of polyol composition (B).

The isocyanate index of the non-solvent polyurethane system is typically in the range from 80 to 200, preferably from 90 to 160.

The present invention further provides a process for producing an artificial leather comprising top coat, polyurethane layer and optional substrate layer, said process comprising i) applying at least one layer of a top coat to a release layer to produce an overall top coat layer, ii) applying a first polyurethane system to the top coat to form a first polyurethane layer, iii) optionally applying a further polyurethane system to the first polyurethane layer to form at least one further polyurethane layer, iv) optionally applying a substrate layer to the first polyurethane layer or to the further polyurethane layers, v) curing the first polyurethane system and optionally the further polyurethane system to form a second polyurethane layer, vi) separating the release layer from the top coat, to form an artificial leather, wherein the first polyurethane system is made from the non-solvent polyurethane system described above.

The process of the present invention comprises a release layer in step i). In principle, any layer is useful as release layer that allows polyurethane system components to be applied thereto and reacted to form polyurethane and the resulting polyurethane to be separated again from the release layer. Release layer thickness is typically in the range from 0.001 millimeters (mm) to 10 mm, preferably in the range from 0.01 mm to 5 mm and more particularly in the range from 0.1 mm to 2 mm.

Suitable release layers are typically known in the pertinent art as “release paper”. Examples of suitable release layers are layers, for example foils, of metal, plastic or paper.

In one preferred embodiment, the release layer used is a paper layer optionally coated with a plastic. Preferably, the paper layer here is coated with a polyolefin, preferably polypropylene. Alternatively, the paper layer is preferably coated with silicone.

In an alternative preferred embodiment, the release layer used is a PET layer (=polyethylene terephthalate) optionally coated with a plastic. Preferably, the PET layer here is coated with a polyolefin, preferably polypropylene. Alternatively, the PET layer is preferably coated with silicone.

Examples of suitable release layers are commercially available. Examples of renowned manufacturers in the pertinent art include Warren (Sappi, USA), Binda (Italy), Arjo Wiggins (UK/USA) und Lintec (Japan).

The release layers used may have a smooth or uneven surface. The type of release layer depends on the surface desired for the polymer layer resulting from the process of the present invention. When it is desired for a resulting polyurethane layer to have a smooth surface, the release layer will likewise have a smooth surface. When a resulting polyurethane layer is desired to have an uneven or patterned surface, the release layer will likewise have an uneven or patterned surface. Preferably, the release layer is patterned such that the product has a leather grain.

Step i) also comprises applying a top coat to the release layer. The top coats used can be of the type typically used in the production of leather or leather imitations. These comprise polyurethane-based top coats, such as solventborne polyurethane coats or waterborne polyurethane dispersion coats, preferably waterborne polyurethane dispersion coats. Suitable coats may be based on a linear MDI-polyether-based polyurethane and be in a state of solution in DMF for example. Coats based on aliphatic isocyanates and polyesters or polyethers are likewise conceivable. These coats can be cured by addition of curatives, for example by addition of carbodiimide-based curative. The amount of curative added controls the hardness of the top coat obtained. The hardness of the top coat is preferably conformed to the hardness of the polyurethane layer. Preferably, the polyurethane coats comprise addition agents, such as dyes or pigments. Such polyurethane coats are described for example in EP1905789 and WO2009112168, which are incorporated herein by reference. Examples of waterborne polyurethane coats are Astacin® PR and Astacin® PW from BASF SE or Impranil® from Bayer Material Science. One coat layer can be applied or two or more coat layers can be applied on top of each other, in which case the starting materials for producing the respective coat layers can be the same or different. These coats are preferably applied by spraying the release layer or by knifecoating.

The overall thickness of the coat layers applied to the release layer is in the range from 1 to 500 μm, preferably in the range from 5 to 100 μm and more preferably in the range from 10 to 90 μm.

The coat layer is preferably dried, for example by allowing it to flash off or heating, before the polyurethane system components are applied. In the event that two or more layers of top coat are applied, it is particularly preferable to dry the applied layer before the subsequent layer of top coat is applied.

Step ii) comprises applying a first polyurethane system to the top coat to form a first polyurethane layer and optional step iii) comprises applying a further polyurethane system to the first polyurethane layer to form at least one further polyurethane layer. Application of the first polyurethane system components to produce the first polyurethane layer and also of the optional further polyurethane system components is preferably done uniformly, i.e., the polyurethane system components are applied such that the entire surface of the release layer is covered with polyurethane system components.

The non-solvent polyurethane system components can generally be applied using any method whereby it is possible to apply a layer of polyurethane system components which are curable to a polyurethane layer of suitable thickness. The non-solvent polyurethane system components are preferably applied by casting, blade coating or spraying.

Casting typically refers to the application of the liquid material (non-solvent polyurethane system components) by means of a mixing head. It is preferable to use commonly employed mixing heads operated under high or low pressure; for example, Puro-mats from Krauss Maffei or Hennecke are used as metering unit. The material is preferably applied in a laminar stream of material.

Preferably, the material applied is spread to a homogeneous layer thickness by blade coating with scrapers, for example spatulas. The material can further also be applied via wide-slit dies.

Spraying refers to application of the liquid material via a spray head. The spray head preferably atomizes the material into droplets and more particularly into fine droplets. A fan-shaped jet of spray is preferably formed in the process. It is preferable here for the polyurethane system components to be spray applied in the form of particles (which particles are preferably in the form of droplets, having a particle diameter in the range from 1 to 500 μm and more preferably in the range from 10 to 100 μm.

The non-solvent polyurethane system components are typically applied in the process of the present invention in an amount such that the resulting polyurethane layer has a thickness in the range from 0.01 millimeters (mm) to 20 mm, preferably in the range from 0.05 mm to 10 mm and more preferably in the range from 0.05 mm to 5 mm. The overall thickness of the first polyurethane layer and of optional further polyurethane layers is less than 20 mm, preferably in the range from 0.05 to 10 mm and more preferably in the range from 0.1 mm to 5 mm. This does not include the thickness of the top coat even when the top coat is a polyurethane-based top coat.

The polyurethane layer here may be effected by applying a first layer of polyurethane system components and also optionally further layers of polyurethane system components. Preferably, only one layer of polyurethane system components is applied to the top coat.

When two or more layers of polyurethane system components are applied, the second and each further layer are preferably applied to the underlying layer of polyurethane system components. This underlying layer of polyurethane system components may already be cured to such an extent before applying a further layer that the underlying layer is no longer fluent; alternatively, however, it may also still be fluent. Preferably, the underlying polyurethane layer at the time of applying the next polyurethane layer is no longer fluent but only cured to such an extent that it will adhere to a wooden spatula when contacted therewith. The curing of polyurethane system components may for example be speeded by heating or by irradiation, for example with microwave radiation or infrared radiation.

The non-solvent polyurethane system components for forming the first and any one of the respectively further polyurethane layers can be the same or different. For instance, the polyurethane system components for forming the first polyurethane layer include blowing agent, while the polyurethane system components for forming one of the subsequent polyurethane layers do not comprise blowing agent. The polyurethane layers are preferably produced by utilizing the same isocyanates (a) and polyols (b) in each case. It is particularly preferable for the polyurethane system components for forming the first polyurethane layer to differ from those for forming the second polyurethane layer in the isocyanate index only.

The process of the present invention generally has non-solvent polyurethane system comprising components (A) and composition (B) being reacted in such amounts that the equivalence ratio of NCO groups to the sum total of reactive hydrogen atoms is in the range from 0.8:1 to 2:1 and preferably in the range from 0.9:1.0 to 1.6:1. A ratio of 1:1 here corresponds to an NCO index of 100. It is an essential feature of the present invention that the equivalence ratio of NCO groups to the sum total of reactive hydrogen atoms in the polyurethane system components for forming the polyurethane layer which is in direct contact with the top coat is in the range from 0.8:1 to 2:1, preferably in the range from 0.9:1.0 to 1.6:1, which corresponds to an isocyanate index in the range from 80 to 200, preferably in the range from 90 to 160.

The term “solvent” is common knowledge in the pertinent art. Solvent for the purposes of the present invention is to be understood in the widest sense as comprehending organic and inorganic liquids capable of dissolving other solid materials in a physical way. The prerequisite for a material to be useful as a solvent is that neither the dissolving material nor the dissolved material undergoes chemical changes in the course of the process of dissolution. Thus, the dissolved component can be recovered by physical methods of separation, such as distillation, crystallization, sublimation, evaporation and/or adsorption for example.

In the context of this invention, the non-solvent polyurethane system means that the polyurethane system components comprise essentially no organic solvent. More particularly the polyurethane system components comprise essentially no ether or glycol ether (such as diethyl ether, dibutyl ether, anisole, dioxane, monomeric tetrahydrofuran), ketones (such as acetone, butanone, cyclohexanone), esters (such as ethyl acetate), nitrogen compounds (such as dimethylformamide, pyridine, N-methylpyrrolidone, acetonitrile), sulfur compounds (such as carbon sulfide, dimethyl sulfoxide, sulfolane), nitro compounds (such as nitrobenzene), (hydro)halocarbons (such as dichloro-methane, chloroform, tetrachloromethane, trichloroethene, tetrachloroethene, 1,2-di-chloroethane, chlorofluorocarbons), hydrocarbons, preferably with boiling point above 60° C. (such as octane, methylcyclohexane, decalin, benzene, toluene, xylene).

The optional step iv) of the process according to the present invention comprises applying a substrate layer to the to the first polyurethane layer or to the further polyurethane layers. The substrate layer is preferably applied as long as the polyurethane system components are not fully cured, i.e., as long as there is still an ongoing reaction of isocyanate groups with OH groups. In principle, the substrate layer can be any layer capable of forming an adhering bond with the resulting polyurethane layer.

Substrate layer thickness is typically in the range from 0.01 millimeters (mm) to 20 mm, preferably in the range from 0.1 mm to 10 mm and more particularly in the range from 0.3 mm to 5 mm.

Examples of suitable release layers are layers, for example foils, of metal, plastic, leather and/or textile materials.

Various kinds of substrate layers are possible for the process of the present invention, examples being:

A fabric substrate layer: In this case the substrate layer can consist of one or more, identical or different, firmly interconnected plies, for example of narrowly or widely meshed woven, knits, braids, networks (net cloths).

Batt substrate layer: sheetlike structures composed of randomly disposed fibers (examples being felts and fibrous webs), which may preferably be bound together by a binder. Batt substrate layers are usually cellulosic or textile batts consolidated with water-insoluble impregnates.

Fibrous substrate layer: articles of manufacture composed of loose, randomly disposed fibers which are consolidated by plastics being used as a binder. They are obtained for example by adhering together leather fibers (preferably obtainable from leather waste, for example from vegetable-tanned leather) with 8-40% by weight of a binder.

Foil substrate layer: articles of manufacture comprising (preferably homogeneous) foils composed of metal or plastic, for example rubber, PVC, polyamides, interpolymers and the like. A foil substrate layer preferably comprises no incorporated fiber.

One preferred embodiment utilizes a leather layer as substrate layer. When a leather layer is used, the leather in question is preferably split leather.

When a textile layer is used, the following materials will be particularly suitable to produce the textile layer: cotton, linen, polyester, polyamide and/or polyurethane.

Applying the substrate layer is preferably done as long as the most recently applied polyurethane system components are still fluent or are already cured to such an extent that they are no longer fluent but adhere to a wooden spatula on contact therewith.

The substrate layer is applied to the polyurethane system components by bringing the former into contact with the latter and pressing. The contact pressure is preferably between 0.01 and 6 bar and more preferably between 0.05 and 5 bar. The pressing time is between 0.1 sec and 100 sec and preferably between 0.5 sec and 15 seconds (sec).

When the polyurethane system components of the most recently applied polyurethane layer are already in a cured state, the substrate layer can also be applied to the polyurethane layer with the aid of a customary adhesive. Examples of such preferably sol-vent-free adhesives are one-component polyurethane adhesives or two-component polyurethane adhesives.

Step v) of the process according to the present invention comprises curing the non-solvent polyurethane system to form the polyurethane layer. This curing may be hastened by temperature elevation, for example in an oven, or by irradiation, for example with microwave radiation or infrared radiation.

Usually the curing temperature needs to be at above 100° C. to achieve required curing degree, however, in the current invention, the curing is effected at temperatures in the range from 65 to 100° C., preferably from 65 to 80° C. The curing operation continues until the reaction of isocyanate groups with OH-functional groups is essentially complete. The duration of the curing operation is preferably in the range from 0.5 to 20 minutes, more preferably in the range from 1 to 15 minutes and more particularly in the range from 5 to 10 minutes.

If desired, the material may subsequently be further conditioned at 60-100° C. for up to 24 hours.

Step vi) of the process according to the present invention comprises separating the release layer from the polyurethane layer. The separating may be effected by the customary methods known in the prior art. For example, the release layer is peeled off the polyurethane layer. This polyurethane layer is preferably in a fully cured state before the release layer is separated off.

The process of the present invention may be carried out as a continuous operation or as a batch operation. It is preferably carried out as a continuous operation.

Continuous in this context is to be understood as meaning that the release layer and, if used, the substrate layer are present in the form of bands which are continuously advanced and treated according to the process of the present invention. The bands are generally from 10 to 500 meters and preferably from 20 to 200 meters in length. The band speed is typically in the range from 5 to 15 m/min.

In one continuous process of the present invention, the release layer forms a quasi release band. The release layer is preferably unwound off a spindle at the start of the process, the release layer removed from the polyurethane layer in the process of the present invention may preferably be wound up again on a spindle. This wound-up release layer may be reused in the process of the present invention; that is, it is reusable. The wound-up release layer is preferably reused at least 2 to 5 times.

In one continuous process of the present invention, the substrate layer forms a quasi substrate band. The substrate layer is preferably unwound off a spindle at the start of the process. This continuous process of the present invention provides artificial leather comprising top coat, polyurethane layer and optional substrate layer, as a process product which is likewise present in the form of a band. The product obtained is preferably wound up on a spindle. When the process of production is continuous, the layer of a top coat can be applied by spraying, by blade coating or by a wide slot die. The polyurethane system may subsequently be applied by spraying or by blade coating. Any combination of these production variants is possible.

The present invention further provides an artificial leather obtainable by the process of the present invention.

The artificial leather of the present invention, wherein the overall thickness of the first and optionally further polyurethane layer is in the range from 0.01 to 10 mm, preferably from 0.01 to 5 mm, more preferably from 0.01 to 2 mm

In one preferred embodiment, the artificial leather of the present invention, which is obtainable in the process of the present invention, is oriented. Oriented” in this context is to be understood as meaning that the polyurethane layer in the solid state is subjected to tension or pressure in one or two directions (=mono- or uniaxial and biaxial orientation respectively). This orientation leads to an enlargement of the dimensions by a factor of up to 10, preferably to an enlargement of the dimensions by up to a factor in the range from 1.1 to 5 and more preferably to an enlargement of the dimensions by up to a factor in the range from 1.2 to 2. The orientation preferably leads to an improvement in the breathability of the artificial leather of the present invention. The breathability of this artificial leather is preferably in the range from 0.5 to 15 mg/cm2 and more preferably in the range from 3.5 to 8.5 mg/cm2, as measured to DIN EN ISO 14268.

The artificial leather of the present invention is useful for numerous applications. Examples include the upper or covering material in the application of apparel, accessories, cases, electronic devices, furniture, auto upholstery, sports items or other leisure products.

### Examples

The present invention will now be described with reference to Examples and Comparative Examples, which are not intended to limit the present invention.

The following raw materials were used:
Top coat 1: MDI-polyether-based, linear polyurethane in DMF
Top coat 2: waterborne polyurethane coat based on aliphatic isocyanate and polyether
Isocynate: Prepolymer based on monomeric MDI and polytetrahydrofuran with an OH number of 56 mgKOH/g
Polyol 1 is polyether polyol capped with primary hydroxyl, with molecular weight (g/mol) of 4000-6000, and hydroxyl number (OHv) of 30-40 mgKOH/g
Polyol 2 is polyether polyol capped with primary hydroxyl, with molecular weight (g/mol) of 2000-4000, and hydroxyl number (OHv) of 25-35 mgKOH/g
Chain extender: 1,4-butanediol
Catalyst 1: mixture contains 8-Oxa-3,5-dithia-4-stannatetradecanoic acid, 10-ethyl-4-[[2-[(2-ethylhexyl)oxy]-2-oxoethyl]thio]-4-methyl-7-oxo-, 2-ethylhexyl ester (10%-30%) and 8-Oxa-3,5-dithia-4-stannatetradecanoic acid, 10-ethyl-4,4-dimethyl-7-oxo-, 2-ethylhexyl ester (70%-100%)
Catalyst 2: Triethylene diamine(33%) and dipropylene glycol(67%)
Catalyst 3: Neodecanoic acid, zinc salt
Catalyst 4: Zinc carboxylate (90-100%) and Diethylene glycol monoethyl ether(5-<10%)
Catalyst 5: Phenol, compd. with 2,3,4,6,7,8,9,10-octahydropyrimido[1,2-a]azepine (1:1)
Stabilizer: Niax Silicone L-5302
Release paper: Favini B100 from Favini
   The Following Test Method were Used

Peeling strength: refer to the standard GB 8808-88 B and operated as below,
The release paper was removed from the leather specimen. The leather specimen was cut into a dimension of 20 cm×3 cm, and coated with epoxy glue on the outmost surface of the top coating layer. Then it was folded with the epoxy coated surface facing together to form a 10 cm×3 cm specimen. It was pressed, and cured at room temperature for 3 hours. Then T-model peel strength test was conducted on ZwickRoell tensile machine with 100 mm/min speed.

Curing property of the 2-component PU layer was judged by using nail to press the top coat of the laminate (the polyurethane artificial leather) and then visually evaluating according to the following grades:
Grade 1: nail print is rebound>10 sec, or the top coat is damaged
Grade 2: nail print rebound (7 sec-9 sec);
Grade 3: nail print rebound (4 sec-6 sec);
Grade 4: nail print rebound (1 sec-3 sec);
Grade 5: no obvious nail print

The following components were used to prepare non-solvent polyurethane layer:

TABLE 1
Formulation of non-solvent polyurethane system (part by weight)

| | Comparative | Comparative | Comparative | | | | | |
|---|---|---|---|---|---|---|---|---|
| | Example 1 | Example 2 | Example 3 | Example 1 | Example 2 | Example 3 | Example 4 | Example 5 |
| Component (B) | | | | | | | | |
| Polyol 1 | 51.92 | 51.7 | 51.7 | 51.7 | 51.7 | 51.75 | 51.6 | 51.3 |
| Polyol 2 | 45 | 45 | 45 | 45 | 45 | 45 | 45 | 45 |
| Chain extender | 2 | 2 | 2 | 2 | 2 | 2 | 2 | 2 |
| water | 0.6 | 0.6 | 0.6 | 0.6 | 0.6 | 0.6 | 0.6 | 0.6 |
| Catalyst 1 | 0.03 | 0.1 | | | | | | |
| Catalyst 2 | | | 0.1 | | | | | |
| Catalyst 3 | | | | 0.1 | | | | |
| Catalyst 4 | | | | | 0.1 | 0.05 | 0.2 | 0.5 |
| Catalyst 5 | 0.05 | 0.2 | 0.2 | 0.2 | 0.2 | 0.2 | 0.2 | 0.2 |
| Stabilizer | 0.4 | 0.4 | 0.4 | 0.4 | 0.4 | 0.4 | 0.4 | 0.4 |
| Total | 100 | 100 | 100 | 100 | 100 | 100 | 100 | 100 |
| Component (A) | | | | | | | | |
| Isocyanate | 60 | 60 | 60 | 60 | 60 | 60 | 60 | 60 |

### Preparation of the Artificial Leather

A release paper travels at a speed of 10 m/min across a continuous rig for artificial leather production. A commercially customary spray gun was used to apply to the release paper a coating layer about 50 micrometers in thickness. The coating consists Top coat 1 (or Top coat 2). The coating layer dries in the oven into which the material was conveyed after application of the coating and delayed therein for about 3 minutes. Thereafter, an approximately 250 micrometers thick layer of the non-solvent polyurethane reactive system (the formulation in Table 1) is applied with low pressure pouring machine. The material is subsequently led through an oven temperature controlled to 120° C. only to reemerge from it after about 90 s. Thereafter, a textile substrate is applied, under slight pressure, to the still incompletely cured polyurethane. Subsequently the polyurethane is cured in the 3rd oven at 50° C.˜100° C. and reemerges from the oven after 10 min. Thereafter, the final artificial leather can be peeled off the release paper

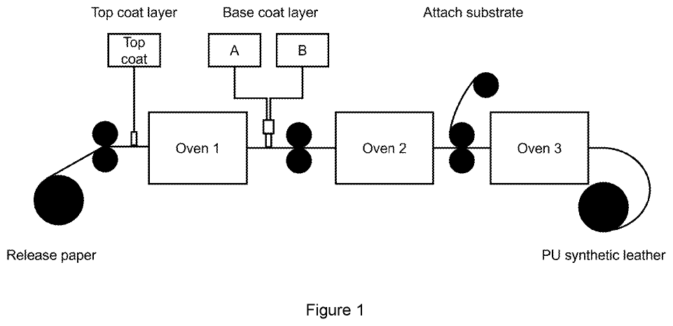

### Processing Refers to FIG. 1.

TABLE 2
Test result of the PU artificial leathers

| | Post Curing | Posting | Peeling | Operating |
|---|---|---|---|---|
| | Temperature | curing | Strength | open time |
| | (° C.) | degree | (N/3 cm) | (s) |
| Comparative | 65 | Grade 5 | 32-36 | 60-70 |
| Example 1 | 80 | Grade 5 | 20-25 | 60-70 |
| Comparative | 65 | Grade 5 | 75-80 | <25 |
| Example 2 | 80 | Grade 5 | 65-75 | <25 |
| Comparative | 65 | Grade 5 | 40-50 | <25 |
| Example 3 | 80 | Grade 5 | 65-70 | <25 |
| Example 1 | 65 | Grade 5 | 60-70 | 60-70 |
| | 80 | Grade 5 | 50-60 | 60-70 |
| Example 2 | 50 | Grade 1 | 10-15 | 60-70 |
| | 65 | Grade 5 | 55-60 | 60-70 |
| | 80 | Grade 5 | 65-70 | 60-70 |
| | 100 | Grade 5 | 60-70 | 60-70 |
| Example 3 | 100 | Grade 5 | 60-70 | 50-60 |
| Example 4 | 80 | Grade 5 | 60-70 | 45-55 |
| Example 5 | 80 | Grade 5 | 60-70 | 45-55 |

From the above results, it can be seen that by using an amine-based catalyst and an organic tin-contained catalyst with different content in comparative examples 1 and 2, the PU synthetic leather can hardly meet the requirement of both peeling strength and operation open time. In comparative examples 3, by using two different types of amine-based catalysts, the PU synthetic leather can achieve good peeling strength, however, the operation open time is not long enough for production requirement. Meanwhile, the PU synthetic leathers obtained in the inventive examples 1-5 by using the inventive catalyst mixture could achieve improved properties which meet both peeling strength and operation open time requirement at a lower curing temperature from 65° C. to 100° C.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions and methods, and such variations are regarded as within the ambit of the invention. Thus, it is intended that the present invention cover such modifications and variations as come within the scope of the appended claims and their equivalents.

1. A non-solvent polyurethane system formed with reactants of
(A) an isocyanate component; and
(B) a polyol composition
wherein the polyol composition (B) comprises catalysts of a non-tin metal compound and an amine-based catalyst.

2. The non-solvent polyurethane system according to claim 1, wherein the non-tin metal compound is selected from the group consisting of Zinc, bismuth, calcium contained organic metal catalyst, and mixtures thereof.

3. The non-solvent polyurethane system according to claim 2, wherein the catalyst is selected from the group consisting of zinc neodecanoate, zinc octoate, zinc naphthenate, zinc tallate, zinc (C9˜C14) carboxylate, zinc acetate, zinc diacetylacetonate, Zinc (2-ethylhexanoate), calcium bis(2-ethylhexanoate), bismuth neodecanoate, bismuth 2-ethylhexanoate, bismuth octanoate, and mixtures thereof.

4. The non-solvent polyurethane system according to claim 1, wherein the amount of non-tin metal compound is in a range of from 0.01 wt % to 10 wt %, based on the total weight of polyol composition (B).

5. The non-solvent polyurethane system according to claim 1, wherein the amine-based catalyst is a blocked amine catalyst.

6. The non-solvent polyurethane system according to claim 5, wherein the amount of amine-based catalyst is in a range from 0.01 wt % to 10 wt %, based on the total weight of polyol composition (B).

7. The non-solvent polyurethane system according to claim 1, wherein the polyol composition (B) comprises polyetherols and/or polyesterols.

8. The non-solvent polyurethane system according to claim 7, wherein the polyetherols comprise polytetrahydrofuran.

9. The non-solvent polyurethane system according to claim 1, wherein the polyol composition (B) further comprises a chain extender.

10. The non-solvent polyurethane system according to claim 1, wherein the polyol composition (B) further comprises a blowing agent.

11. The non-solvent polyurethane system according to claim 1, wherein the polyol composition (B) further comprises auxiliary and/or addition agents.

12. The non-solvent polyurethane system according to claim 1, wherein the isocyanate component (A) comprises polyisocyanates.

13. The non-solvent polyurethane system according to claim 1, wherein an isocyanate index of the non-solvent polyurethane system is in a range from 80 to 200.

14. A process for producing an artificial leather comprising a top coat, a polyurethane layer and an optional substrate layer, the process comprising:
applying at least one layer of a top coat to a release layer to produce an overall top coat layer;
applying a first polyurethane system to the top coat to form a first polyurethane layer;
optionally applying a further polyurethane system to the first polyurethane layer to form at least one further polyurethane layer;
optionally applying a substrate layer to the first polyurethane layer or to the further polyurethane layers;
curing the first polyurethane system and optionally the further polyurethane system to form a second polyurethane layer; and
separating the release layer from the top coat, to form an artificial leather,
wherein the first polyurethane system is made from the non-solvent polyurethane system according to claim 1.

15. The process according to claim 14, which is a continuous process.

16. The process according to claim 14, wherein the curing temperature of curing the first polyurethane system and optionally the further polyurethane system to form a second polyurethane layer is from 65° C. to 100° C.

17. The process according to claim 14, wherein the top coat is formed from an aqueous polyurethane dispersion.

18. The process according to claim 13, wherein the applying of the first polyurethane system and optionally the further polyurethane systems occurs by blade coating.

19. An artificial leather comprising
a top coat,
a first polyurethane layer,
optionally a further polyurethane layer, and
optionally a substrate layer, wherein the first polyurethane layer is formed by the polyurethane system according to claim 1.

20. The artificial leather according to claim 19, which is produced by a process comprising
applying at least one layer of a top coat to a release layer to produce an overall top coat layer;
applying the first polyurethane system to the top coat to form a first polyurethane layer;
optionally applying a further polyurethane system to the first polyurethane layer to form at least one further polyurethane layer;
optionally applying a substrate layer to the first polyurethane layer or to the further polyurethane layers;
curing the first polyurethane system and optionally the further polyurethane system to form a second polyurethane layer; and
separating the release layer from the top coat, to form the artificial leather.

21. The artificial leather according to claim 19, wherein the overall thickness of the first and optionally further polyurethane layer is in a range of from 0.01 to 10 mm.

22. A method of using the artificial leather according to claim 19, the method comprising using the artificial leather as an upper or covering material in an application of apparel, accessories, cases, electronic devices, furniture, auto upholstery, sports items or leisure products.
